(19) United States
(12) Patent Application Publication
(10) Pub. No.: US 2019/0188428 A1
(43) Pub. Date: Jun. 20, 2019

(54) RADIO FREQUENCY IDENTIFICATION (RFID) READING APPARATUS

(71) Applicant: TOSHIBA TEC KABUSHIKI KAISHA, Tokyo (JP)

(72) Inventors: Yasuhiro ONO, Yokohama Kanagawa (JP); Toshiyasu TERAHARA, Mishima Shizuoka (JP)

(21) Appl. No.: 16/212,101

(22) Filed: Dec. 6, 2018

Related U.S. Application Data
(60) Provisional application No. 62/598,906, filed on Dec. 14, 2017.

(30) Foreign Application Priority Data
Aug. 24, 2018 (JP) 2018-157146

(51) Int. Cl. G06K 7/10

(52) U.S. Cl. CPC G06K 7/10316; G06K 7/10366

(57) ABSTRACT

A reading apparatus includes a body, an opening cover, and a radio frequency identification (RFID) antenna. The body has therein a chamber configured to accommodate a container to carry one or more products and an opening through which the container is placeable into the chamber. The opening cover is movably attached to the body between an open position that enables the container to pass through the opening and a closed position that closes the opening. The RFID antenna is positioned to read data in an RFID tag on at least part of the one or more products in the chamber.

### CROSS-REFERENCE TO RELATED APPLICATIONS

This application is based upon and claims the benefit of priority from U.S. Provisional Application No. 62/598,906 filed on Dec. 14, 2017 and Japanese Patent Application No. 2018-157146, filed on Aug. 24, 2018, the entire contents of which are incorporated herein by reference.

### FIELD

Embodiments described herein relate generally to a reading apparatus, in particular, a radio frequency identification (RFID) reading apparatus.

### BACKGROUND

A product sales processing apparatus reads product information from an RFID tag on a product and performs a payment process based on the product information.

There is a type of a product sales processing apparatus, called a self-service-type product sales processing apparatus, with which a customer him/herself performs all works up to bagging. In addition, there is another type of a product sales processing apparatus, called a semi-self-service-type product sales processing apparatus, with which the customer him/herself performs part of the works up to bagging

### DESCRIPTION OF THE DRAWINGS

FIG. 1 is a perspective view showing a configuration of a product sales processing apparatus, according to a first embodiment.

FIG. 2 is a block diagram showing the configuration of the product sales processing apparatus, according to the first embodiment.

FIG. 3 is a perspective view showing a configuration of a product sales processing apparatus, according to a second embodiment.

FIG. 4 is a block diagram showing the configuration of the product sales processing apparatus, according to the second embodiment.

FIG. 5 is a schematic diagram showing a configuration of a reading apparatus used in the product sales processing apparatus according to the second embodiment.

FIG. 6 is a schematic diagram showing a configuration of a modified example of the product sales processing apparatus according to the second embodiment.

FIG. 7 is a schematic diagram showing a configuration of a reading apparatus used in a product sales processing apparatus according to a third embodiment.

FIG. 8 is a block diagram showing a configuration of the product sales processing apparatus according to the third embodiment.

### DETAILED DESCRIPTION

An embodiment provides a reading apparatus directed to reducing a time required for completion of a bagging work of a product.

According to an embodiment, a reading apparatus includes a body, an opening cover, and a radio frequency identification (RFID) antenna. The body has therein a chamber configured to accommodate a container to carry one or more products and an opening facing upward and through which the container is placeable into the chamber. The opening cover is movably attached to the body between an open position that enables the container to pass through the opening and a closed position that closes the opening. The RFID antenna is positioned to read data in an RFID tag on at least part of the one or more products in the chamber.

According to another embodiment, a reading apparatus includes a body, a first opening cover, a second opening cover, and a radio frequency identification (RFID) antenna. The body has therein a chamber configured to accommodate a container to carry one or more products, a first opening on a first side of the chamber, and a second opening on a second side of the chamber opposite to the first side.

The first opening cover is movably attached to the body between a first open position that enables the container to pass through the opening and a first closed position that closes the opening. The second opening cover is movably attached to the body between a second open position that enables the container to pass through the opening and a second closed position that closes the opening. The RFID antenna is positioned to read data in an RFID tag on at least part of the one or more products in the chamber.

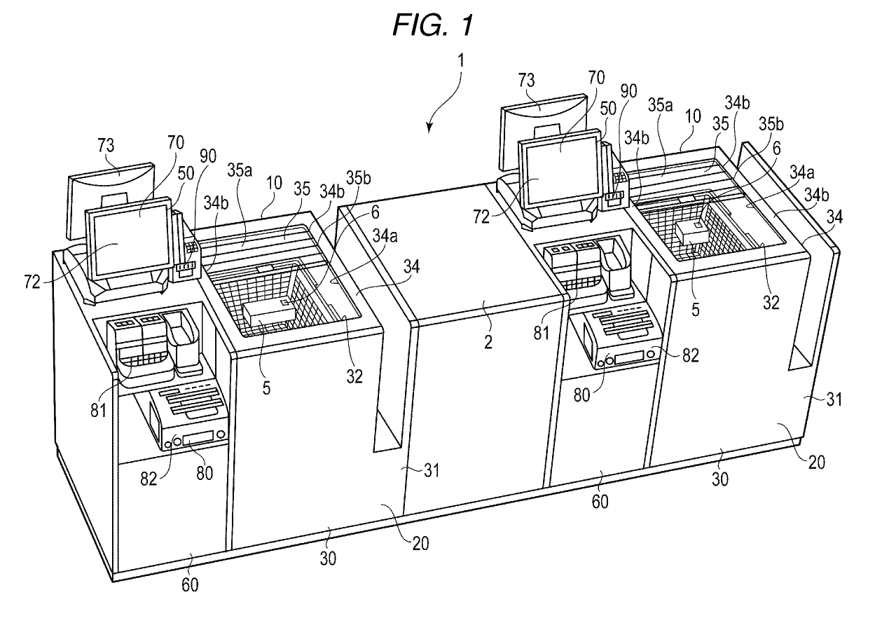

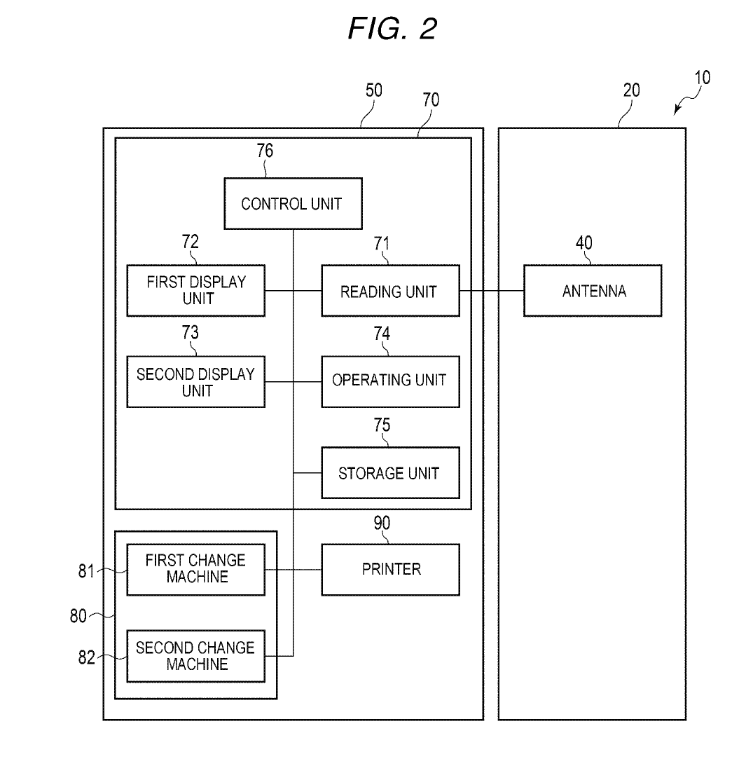

A product sales processing apparatus 10 according to a first embodiment will be described with reference to FIGS. 1 and 2. FIG. 1 is a perspective view showing a configuration of the product sales processing apparatus 10. FIG. 2 is a block diagram showing the configuration of the product sales processing apparatus 10.

As shown in FIG. 1, the product sales processing apparatus 10 includes a reading apparatus 20 and a processing apparatus 50. The product sales processing apparatus 10 receives a signal from a radio frequency identification (RFID) tag 6 of a product 5 by the reading apparatus 20. Also, for example, the product sales processing apparatus 10 reads information of the RFID tag 6 by the processing apparatus 50. In addition, the product sales processing apparatus 10 performs a sales registration process and a payment process according to information of the RFID tag 6 read by the processing apparatus 50.

According to the present embodiment, the sales registration process is a process of preparing a product list based on information of the RFID tag 6. The payment process includes a calculating process and a settlement process. The calculating process is a process of calculating the amount to be paid by a customer based on the product list. In the settlement process, a sales transaction is performed according to payment information of the customer.

Such a product sales processing apparatus 10 is used in, for example, a semi-self-service-type checkout apparatus. In the semi-self-service-type checkout apparatus, a customer him/herself performs a work for the sales registration process and a work for the payment process, and a clerk performs a bagging work of a product. An example of the semi-self-service-type checkout apparatus includes a semi-self-service point-of-sales (POS) system.

The work for the sales registration process may include, for example, a work of accommodating the product 5 in an accommodating chamber 32 such that the product sales processing apparatus 10 may perform the sales registration process. The work for the payment process may include a work requested to the customer when the product sales processing apparatus 10 performs the payment process. The work for the payment process includes, for example, an operation of an operating unit.

Here, the product 5 is a product for sale in a store when the product sales processing apparatus 10 is installed in a store, such as a convenience store. The product 5 includes the RFID tag 6.

The RFID tag 6 includes information of the product 5. The information about the product 5 includes, for example, a name of the product 5, a price of the product 5, and identification information for identifying the product 5. The information included in the RFID tag 6 is not limited thereto. The RFID tag 6 is configured such that information may be read therefrom and written thereon. For example, the RFID tag 6 is a passive tag without a battery, and is configured to be operable in an UHF band.

Here, a front-and-back direction and a left-and-right direction of the product sales processing apparatus 10 are defined. In the product sales processing apparatus 10, a direction in which the reading apparatus 20 and the processing apparatus 50 are arranged is defined as the left-and-right direction. A direction perpendicular to two directions of an up-and-down direction and the left-and-right direction is defined as the front-and-back direction. Then, among the front-and-back direction, a direction in which a first display unit 72 of the processing apparatus 50 faces is defined as a forward direction.

The reading apparatus 20 receives the signal from the RFID tag 6 of the product 5. As shown in FIGS. 1 and 2, the reading apparatus 20 includes a reading apparatus main body 30 and an antenna 40.

The reading apparatus main body 30 includes an outer body 31 and the accommodating chamber 32. The outer body 31 defines an outer shape of the reading apparatus main body 30. The outer body 31 has, for example, a rectangular parallelepiped shape.

The accommodating chamber 32 is provided in the outer body 31. The accommodating chamber 32 is configured such that the product 5 may be accommodated therein. In the present embodiment, the accommodating chamber 32 is configured such that a shopping basket 7 may be accommodated therein. The shopping basket 7 is a container for the customer to carry the unpaid product 5 in the store. The accommodating chamber 32 is not limited to the size capable of accommodating the shopping basket 7. The accommodating chamber 32 may have a size and shape capable of accommodating only the product 5.

The accommodating chamber 32 is configured to be opened or closed by a door 35 described later. An opening 34a is formed on an upper wall portion 34 of the outer body 31. The opening 34a communicates with the accommodating chamber 32. The opening 34a has a shape and size allowing the shopping basket 7 to pass through. For example, the opening 34a has a rectangular shape in a plan view.

The door 35 is provided at the opening 34a. The door 35 is configured to open or close the opening 34a. For example, the door 35 is a shutter. As a specific example, the door 35 includes a door body 35a and a guide portion 35b.

The door body 35a is configured in a blind shape. The door body 35a is, for example, formed of a transparent material such that the inside of the accommodating chamber 32 is visible from the outside. The guide portion 35b is provided on each of two edges of the opening 34a in the front-and-back direction. The guide portion 35b guides the door body 35a to move in the front-and-back direction. The guide portion 35b is, for example, a groove portion accommodating left and right edge portions of the door body 35a.

In the door 35 configured as such, the door body 35a is pushed forward to close the opening 34a. The door body 35a is pushed backward to open the opening 34a.

The antenna 40 is configured to receive the signal from the RFID tag 6 of the product 5 accommodated in the accommodating chamber 32. The antenna 40 is provided on apart of an inner surface of the accommodating chamber 32 as an example of a configuration of an inside of the accommodating chamber 32. However, the antenna 40 may not be provided inside the accommodating chamber 32. The antenna 40 may be provided outside the accommodating chamber 32. As an example of a configuration of the outside of the accommodating chamber 32, the antenna 40 may be provided on an wall portion provided inside the outer body 31 and positioned outside a wall portion defining the inner surface of the accommodating chamber 32.

The processing apparatus 50 is configured to perform the sales registration process and the payment process based on the signal of the RFID tag 6 received by the reading apparatus 20. For example, the processing apparatus 50 includes a housing 60, a terminal 70, a change machine 80, and a printer 90.

The terminal 70, the change machine 80, and the printer 90 are provided in the housing 60. The housing 60 is arranged at the side of the reading apparatus 20.

The terminal 70 includes a reading unit 71, the first display unit 72, a second display unit 73, an operating unit 74, a storage unit 75, and a control unit 76.

The reading unit 71 is electrically connected to the antenna 40 via a signal line. The reading unit 71 reads the information of the RFID tag 6 based on the signal of the RFID tag 6 received by the antenna 40. Further, the reading unit 71 has a function of writing information on the RFID tag 6 through the antenna 40. In other words, according to the present embodiment, the reading unit 71 is a so-called reader/writer.

The reading unit 71 may not be provided in the processing apparatus 50, but may be provided in the reading apparatus 20. For example, the reading unit 71 is provided in the reading apparatus main body 30. In this case, the reading unit 71 may be connected to the control unit 76 via a signal line.

The first display unit 72 is, for example, a liquid crystal display. The first display unit 72 faces forward. The first display unit 72 is a display unit for being mainly visually recognized by the customer. The first display unit 72 displays information required for the customer to, for example, perform the work for the sales registration process and the work for the payment process. Such information includes, for example, information about the product 5, information stored in the storage unit 75, and information about an input/operation of the product sales processing apparatus 10.

The second display unit 73 is, for example, a liquid crystal display. The second display unit 73 faces backward. The second display unit 73 is a display unit mainly visibly recognized by the clerk. The second display unit 73 displays at least information in which the settlement process is completed. As an example in the present embodiment, the second display unit 73 displays the same content as the first display unit 72.

The operating unit 74 is an input device with which the customer inputs information. For example, the operating unit 74 is a touch panel provided on each of the first display unit 72 and the second display unit 73.

The storage unit 75 stores a program executed by the control unit 76, information on sales product registration, and the like. The storage unit 75 includes, for example, a read only memory (ROM) for storing a program such as a control program, and the like, a random access memory (RAM) for temporarily storing information when the control unit 76 executes a program, and the like.

The control unit 76 is, for example, a central processing unit (CPU) or the like. The control unit 76 is electrically connected to the reading unit 71, the first display unit 72, the second display unit 73, the operating unit 74, the storage unit 75, the change machine 80, and the printer 90. The control unit 76 controls each of the electrically connected components by a program stored in the storage unit 75.

The control unit 76 controls the reading unit 71 to read the information of the RFID tag 6 through the antenna 40. The control unit 76 controls the reading unit 71 to write information on the RFID tag 6 through the antenna 40. The control unit 76 controls the reading unit 71, the first and second display units 72 and 73, and the change machine 80 to perform the sales registration process and the payment process.

The change machine 80 processes money input thereinto. The change machine 80 includes, for example, a first change machine 81 for bills and a second change machine 82 for coins.

The printer 90 outputs a receipt on which information of the product 5 for which payment process is completed, and the like are printed.

The product sales processing apparatus 10 configured as such constitutes, for example, a processing unit 1 in pairs. The processing unit 1 includes, for example, two product sales processing apparatuses 10 and a work table 2. The two product sales processing apparatuses 10 are spaced apart from each other in the left-and-right direction. The work table 2 is arranged between the two product sales processing apparatuses 10. An upper surface of the work table 2 is flush with an upper surface 34b of the outer body 31 of the reading apparatus main body 30.

When the sales registration process and the payment process are performed in the product sales processing apparatus 10, the customer stands in front of the product sales processing apparatus 10. When the product sales processing apparatus 10 performs the sales registration process and the payment process, the clerk stands behind the product sales processing apparatus 10.

Hereinafter, an example of a flow using the product sales processing apparatus 10 until a bagging work is completed will be described.

First, the customer moves to the front of the product sales processing apparatus 10 with the product 5. Then, the customer opens the door 35 and accommodates the product 5 in the accommodating chamber 32. When the customer accommodates the product 5 in the shopping basket 7, the customer accommodates the shopping basket 7 in the accommodating chamber 32. Then, the customer performs the work for the sales registration process. The work for the sales registration process denotes, for example, a work of inputting completion of product accommodation in the accommodating chamber 32, via the operating unit 74. Also, the customer performs the work for the payment process. The work for payment process denotes an operation of the operating unit 74, inserting of cash into the change machine 80, or the like.

Upon the settlement process is completed, the control unit 76 displays, on the first display unit 72 and the second display unit 73, information indicating that the settlement process is completed.

Upon checking that the settlement process is completed by looking at the first display unit 72, the customer performs a work of putting a credit card into wallet, a work of putting the wallet into a bag, and the like. Such works are examples of works performed by the customer after the settlement process is completed.

Upon checking that the settlement process is completed by looking at the second display unit 73, the clerk opens the door 35 and takes the product 5 out of the accommodating chamber 32. Then, the clerk performs the bagging work of the product 5 on the work table 2 or at the door 35 in a closed state. Upon completing the bagging work of the product 5, the clerk hands a bag containing the product 5 to the customer.

Accordingly, after settlement process is completed, the works by the customer and the bagging work of the product 5 by the clerk are simultaneously performed.

In the product sales processing apparatus 10 of the present embodiment, the door 35 is provided on the upper wall portion 34 of the outer body 31. Accordingly, the customer standing in front of the product sales processing apparatus 10 and the clerk standing behind the product sales processing apparatus 10 are able to open or close the door 35 from their respective positions.

Thus, when the settlement process is completed, the clerk is able to open the door 35, take the product 5 out of the accommodating chamber 32, and perform the bagging work of the product 5. The clerk is able to perform the bagging work of the product 5 during the work of putting away the wallet, and the like by the customer. Accordingly, it is possible to reduce time required for the completion of the bagging work.

In the present embodiment, a shutter is used as an example of the door 35. However, the door 35 is not limited to the shutter. For example, the door 35 may be a plate-shaped door rotatably provided in a rotation shaft provided at an edge of the opening 34a. Alternatively, the door 35 may be an accordion curtain.

The reading apparatus 20 may include a lift mechanism and an opening and closing mechanism for automatically opening or closing the door 35. The lift mechanism is configured to move a bottom surface 32d of the accommodating chamber 32 up and down. For example, when the control unit 76 detects, via a sensor or the like, that the product 5 is left in the accommodating chamber 32 for a certain period of time after the settlement process is completed, the control unit 76 opens the door 35 by using the opening and closing mechanism and moves the bottom surface 32d upward by using the lift mechanism. When the bottom surface 32d is moved upward, the customer or the clerk notices the product 5 left in the accommodating chamber 32. Alternatively, since a part of the shopping basket 7 sticks out, the customer or the clerk notices the product 5.

Also, in a product waiting state, the control unit 76 may position the bottom surface 32d at a height at which a part of the shopping basket 7 sticks out of the opening 34a, and when a reading work starts, the control unit 76 lowers the bottom surface 32d and automatically closes the door 35. Then, when the settlement process is completed, the control unit 76 may automatically open the door 35 and raise the bottom surface 32d.

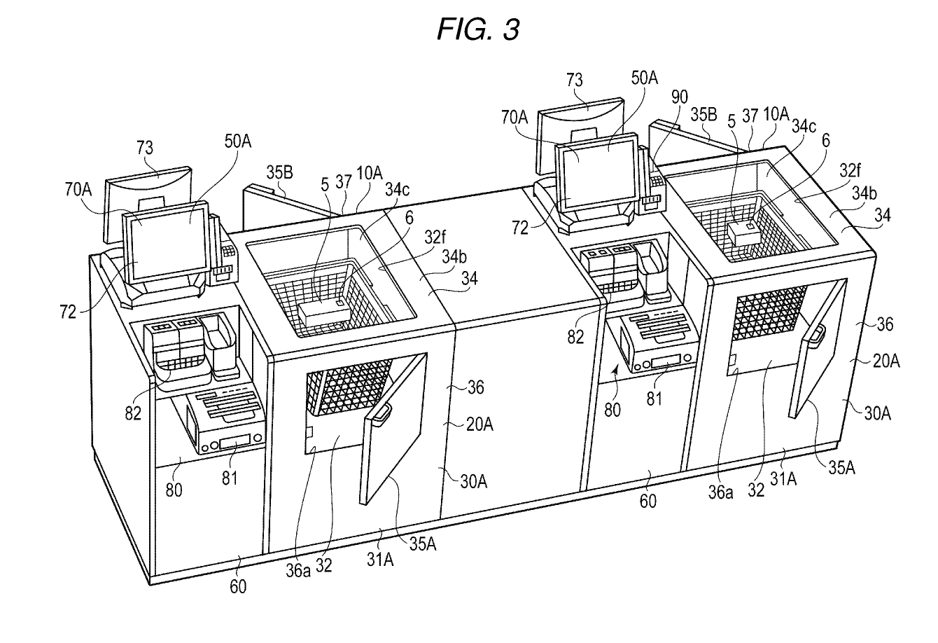

Next, a product sales processing apparatus 10A according to a second embodiment will be described with reference to FIGS. 3 through 5. Here, components having the same functions as the first embodiment are denoted the same reference numerals as the first embodiment, descriptions thereof are omitted.

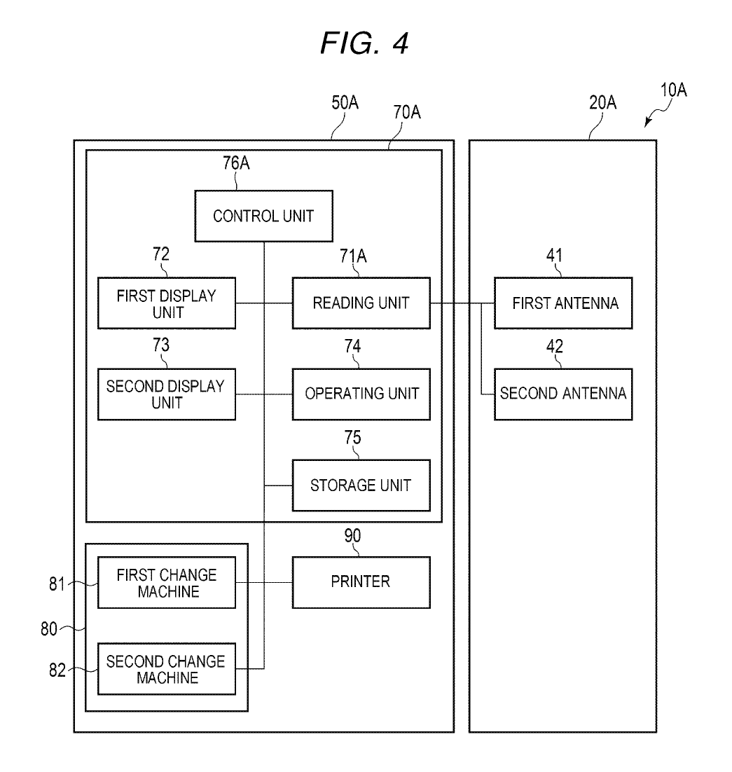

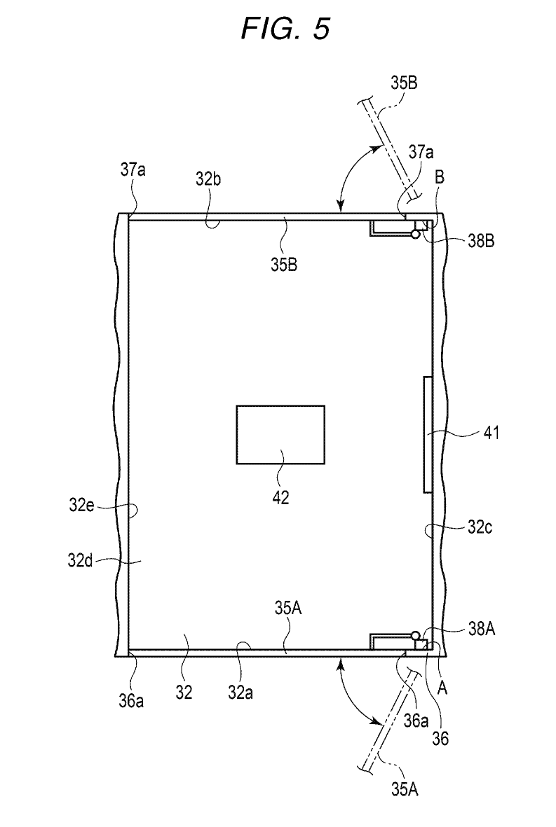

FIG. 3 is a perspective view showing a configuration of the product sales processing apparatus 10A. FIG. 4 is a block diagram showing the configuration of the product sales processing apparatus 10A. FIG. 5 is a schematic diagram showing a configuration of a reading apparatus 20A used in the product sales processing apparatus 10A. In FIG. 5, the inside of the accommodating chamber 32 is viewed from the above.

As shown in FIGS. 3 through 5, the product sales processing apparatus 10A includes the reading apparatus 20A and a processing apparatus 50A. The reading apparatus 20A includes a reading main body 30A, a first antenna 41, and a second antenna 42.

The reading apparatus main body 30A includes an outer body 31A and the accommodating chamber 32. The outer body 31A has, for example, a rectangular parallelepiped shape. The accommodating chamber 32 is provided in the outer body 31A.

The accommodating chamber 32 has a shape in which the length in a front-and-back direction is longer than the length in a left-and-right direction so as to accommodate the shopping basket 7 having a rectangular parallelepiped shape. In other words, as shown in FIG. 5, a distance from a front surface 32a of the accommodating chamber 32 to a rear surface 32b of the accommodating chamber 32 in the front-and-back direction is longer than a distance from a right surface 32c of the accommodating chamber 32 to a left surface 32e of the accommodating chamber 32 in the left-and-right direction. In the present embodiment, the accommodating chamber 32 is configured, for example, as a rectangular parallelepiped chamber space. In other words, a shape formed by the front surface 32a, the rear surface 32b, the right surface 32c, the bottom surface 32d, the left surface 32e, and a top surface 32f of the accommodating chamber 32 forms a rectangular parallelepiped shape.

The outer body 31A includes the upper wall portion 34, a front wall portion 36, and a rear wall portion 37. Also, in the present embodiment, both side portions of the outer body 31A contact the work table 2 or the processing apparatus 50A. Accordingly, the outer body 31A may be configured to include left and right side wall portions or may be configured not to include the left and right side wall portions.

The front wall portion 36 and the rear wall portion 37 are portions of peripheral wall portion of the outer body 31A. The peripheral wall portion is a wall portion along an axial direction parallel to an up-and-down direction among an outer wall portion of the outer body 31A. In other words, the peripheral wall portion is a wall portion excluding an upper wall portion and a bottom wall portion of the outer body 31A.

When the outer wall portion of the outer body 31A has a cylindrical shape or a bottom-closed cylindrical shape, a cylindrical portion becomes the peripheral wall portion. Also, when the outer body 31A has a rectangular parallelepiped shape, a cubic shape, or a polyhedron shape, the peripheral wall portion has a plurality of side surfaces. In the present embodiment, when there are a plurality of side surfaces, wall portions defining the side surfaces are referred to as side wall portions. The side wall portion is a portion of the peripheral wall portion.

The upper wall portion 34 is configured such that the customer is able to visually recognize the accommodating chamber 32. As a specific example, the upper wall portion 34 partially includes a transparent portion 34c. The transparent portion 34c is formed of a transparent material. The transparent portion 34c has, for example, a rectangular shape. The transparent material is, for example, colorless glass.

The upper surface 34b of the upper wall portion 34 is formed so as to be used, for example, as a work table for product bagging. As a specific example, the upper surface 34b (including the transparent portion 34c) is formed as a horizontal plane.

The front wall portion 36 includes a door 35A. An opening 36a is formed on the front wall portion 36. The opening 36a communicates with the accommodating chamber 32. The opening 36a has, for example, a rectangular shape. Also, for example, an upper edge and a lower edge of the opening 36a are horizontally formed.

The door 35A has, for example, a plate-shape having the same shape and size as the opening 36a. By opening or closing the door 35A, the opening 36a is opened or closed. The door 35A provided at the opening 36a is a door operated by the customer.

The door 35A is provided to be rotatable using a first hinge 38A. The first hinge 38A is provided on the right side or the left side of the opening 36a so as not to interfere with the shopping basket 7 placed from the opening 36a. The accommodating chamber 32 has a space in which the first hinge 38A is able to be set on the left or right side of the opening 36a. Accordingly, the front surface 32a has a width corresponding to the space between the opening 36a and a side surface among the right surface 32c and the left surface 32e, where the first hinge 38A is provided with respect to the opening 36a.

In the present embodiment, the first hinge 38A is fixed to the right side of the opening 36a. Also, as an example of the right side, the first hinge 38A is fixed to a part of a range A of the front surface 32a between the opening 36a and the right surface 32c, in the present embodiment. The range A is a range from the opening 36a to the right surface 32c in a circumferential direction, and is a range from top to bottom of the front surface 32a in the up-and-down direction.

A rotation shaft of the first hinge 38A is parallel in the up-and-down direction. Also, the first hinge 38A may be fixed to a corner portion of the bottom surface 32d between the front surface 32a and the right surface 32c. Alternatively, the first hinge 38A may be fixed to a corner portion of the top surface 32f between the front surface 32a and the right surface 32c.

The opening 36a and the door 35A are configured such that the product 5 may pass through the opening 36a when the door 35A is opened. In the present embodiment, as a specific example, the opening 36a and the door 35A have sizes and shapes such that the shopping basket 7 may pass through the opening 36a when the door 35A is opened up to a predetermined position.

The rear wall portion 37 includes a door 35B. The rear wall portion 37 includes an opening 37a. The opening 37a communicates with the accommodating chamber 32. The opening 37a has, for example, a rectangular shape. Also, for example, an upper edge and a lower edge of the opening 37a are horizontally formed.

The door 35B has, for example, a plate-shape having the same shape and size as the opening 37a. By opening or closing the door 35B, the opening 37a is opened or closed. The door 35B provided at the opening 37a is a door operated by the clerk.

The door 35B is provided to be rotatable using a second hinge 38B. The second hinge 38B is fixed to, from among the right side or the left side of the opening 37a, a side of the first hinge 38A with respect to the opening 36a.

In the present embodiment, since the first hinge 38A is fixed to the right side of the opening 36a, the second hinge 38B is fixed to the right side of the opening 37a. The accommodating chamber 32 has a space in which the second hinge 38B may be set on the right side of the opening 37a. In order to secure such a space, the opening 37a is provided on the left side of the right surface 32c. In other words, the rear surface 32b has a width corresponding to the space between the right surface 32c and the opening 36a.

In the present embodiment, for example, the second hinge 38B is fixed to a part of a range B of the rear surface 32b between the opening 37a and the right surface 32c. The range B is a range from the opening 37a to the right surface 32c in a circumferential direction, and a range from top to bottom of the front surface 32a in the up-and-down direction.

A rotation shaft of the second hinge 38B is parallel in the up-and-down direction. The second hinge 38B may be fixed to a corner portion of the bottom surface 32d between the rear surface 32b and the right surface 32c. Alternatively, the second hinge 38B may be fixed to a corner portion of the top surface 32f between the rear surface 32b and the right surface 32c.

The opening 37a and the door 35B are configured such that the product 5 may pass through the opening 37a when the door 35B is opened. In the present embodiment, the opening 37a and the door 35B have sizes and shapes such that the shopping basket 7 may pass through the opening 37a when the door 35B is opened up to a predetermined position.

The first antenna 41 is provided, among four side surfaces of the accommodating chamber 32, the right surface 32c that is a side surface of a side where the first and second hinges 38A and 38B of the openings 36a and 37a are fixed. In other words, the first antenna 41 is provided in the accommodating chamber 32 by using a space for fixing the first and second hinges 38A and 38B. Accordingly, even when the shopping basket 7 is placed from the opening 36a, the shopping basket 7 does not interfere with the first antenna 41. The first antenna 41 emits radio waves towards the left surface 32e.

The second antenna 42 is provided on the bottom surface 32d. The second antenna 42 emits radio waves towards the top surface 32f of the accommodating chamber 32. The second antenna 42 is not limited to being provided on the bottom surface 32d. The second antenna 42 is provided, for example, below the bottom surface 32d. In this example, the second antenna 42 is provided on a rear surface of a wall portion having the bottom surface 32d or another wall portion provided below the wall portion having the bottom surface 32d.

The processing apparatus 50A includes, for example, the housing 60, a terminal 70A, the change machine 80, and the printer 90.

The terminal 70A includes a reading unit 71A, the first display unit 72, the second display unit 73, the operating unit 74, the storage unit 75, and a control unit 76A.

The reading unit 71A is electrically connected to the first and second antennas 41 and 42 through signal lines. The reading unit 71A reads information of the RFID tag 6 based on a signal of the RFID tag 6 received by the first and second antennas 41 and 42. Also, the reading unit 71A has a function of writing information on the RFID tag 6 through the first and second antennas 41 and 42. In other words, the reading unit 71A is a so-called reader/writer in the present embodiment.

The reading unit 71A may not be provided in the processing apparatus 50A, but may be provided in the reading apparatus 20A. For example, the reading unit 71A may be provided in the reading apparatus main body 30A. In this case, the reading unit 71A may be connected to the control unit 76A through a signal line.

The control unit 76A is, for example, a central processing unit (CPU) or the like. The control unit 76A is electrically connected to the reading unit 71A, the first display unit 72, the second display unit 73, the operation unit 74, the storage unit 75, the change machine 80, and the printer 90. The control unit 76A controls each of the electrically connected components in accordance with a program stored in the storage unit 75.

The control unit 76A controls the reading unit 71A to read the information of the RFID tag 6 through the first and second antennas 41 and 42. The control unit 76A controls the reading unit 71 to write information on the RFID tag 6 through the first and second antennas 41 and 42. The control unit 76A controls the reading unit 71A, the first display unit 72, the second display unit 73, and the change machine 80 to perform the sales registration process and the payment process.

Next, an example of a flow using the product sales processing apparatus 10A until a work of product bagging is completed will be described.

First, the customer moves to the front of the product sales processing apparatus 10A with the product 5. Then, the customer opens the door 35A and puts the product 5 in the accommodating chamber 32. When the customer puts the product 5 in the shopping basket 7, the customer places the shopping basket 7 in the accommodating chamber 32. Then, the customer performs the work for the sales registration process and the work for the payment process.

When the settlement process is completed, the control unit 76A displays information indicating that the settlement process is completed on the first display unit 72 and the second display unit 73.

Upon checking that the settlement process is completed by looking at the first display unit 72, the customer performs a work of putting a credit card into a wallet, a work of putting the wallet into a bag, and the like.

Upon checking that the settlement process is completed by looking at the second display unit 73, the clerk opens the door 35B and takes the product 5 out of the accommodating chamber 32. Then, the clerk performs a bagging work of the product 5 on the work table 2 or the upper wall portion 34. When the bagging work of the product 5 is completed, the clerk hands a bag containing the product 5 to the customer.

In this manner, the works by the customer and the bagging work of the product 5 by the clerk can be simultaneously performed.

In the present embodiments, the same effects as the first embodiment may be obtained.

Also, the first antenna 41 is fixed to the right surface 32c that is a side surface of a side where the first and second hinges 38A and 38B are provided from among right and left sides of the openings 36a and 37a. That is, the first antenna 41 is arranged in a space secured in the accommodating chamber 32 so as to fix the first and second hinges 38A and 38B.

For that reason, it is not required to secure an installation space for the first antenna 41 to prevent the first antenna 41 from interfering with the shopping basket 7, in addition to a space for fixing the first and second hinges 38A and 38B in the accommodating chamber 32.

For example, when the first antenna 41 is fixed to the left surface 32e, a space for preventing the first antenna 41 from interfering with the shopping basket 7 needs to be secured in the accommodating chamber 32 on the left with respect to the openings 36a and 37a.

In such a configuration, since the accommodating chamber 32 has spaces for the first and second hinges 38A and 38B and a space for the first antenna 41, a distance from the right surface 32c to the left surface 32e would be increased, and thus the volume of the accommodating chamber 32 would be increased. As a result, the outer body 31A would be enlarged.

However, in the present embodiment, since the first antenna 41 is arranged by using installation spaces of the first and second hinges 38A and 38B, there is no need to secure an installation space for the first antenna 41, and thus the enlargement of the outer body 31A may be prevented.

In the present embodiment, the door 35A at which the customer works is included in the front wall portion 36 of the outer body 31A. Also, the door 35B at which the clerk works is included in the rear wall portion 37 of the outer body 31A. This is because in the product sales processing apparatus 10A, the customer stands in front of the apparatus and the clerk stands behind the apparatus.

However, the reading apparatus 20A is not limited a configuration in which the door 35A operated by the customer is included in the front wall portion 36 and the door 35B operated by the clerk is included in the rear wall portion 37. Positions of the doors 35A and 35B may be determined based on positions of the customer and the clerk by the product sales processing apparatus 10A.

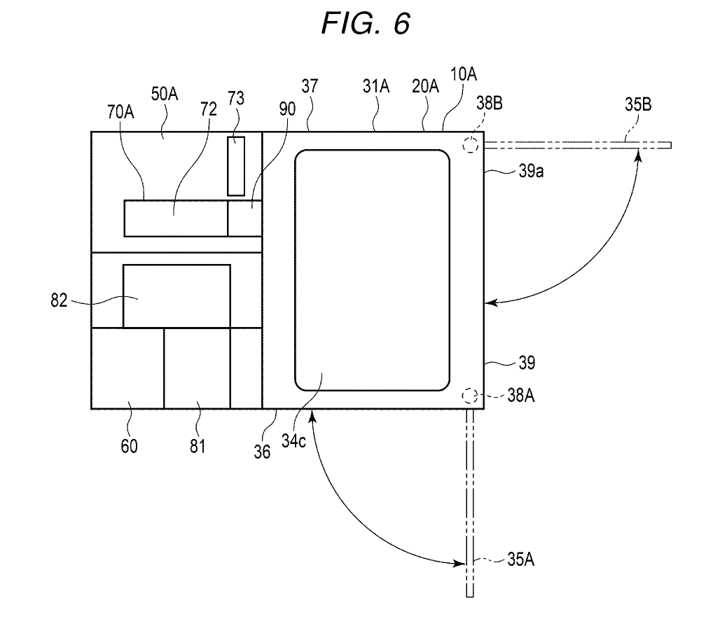

A modified example will be described with reference to FIG. 6. In the modified example of FIG. 6, a right wall portion 39 includes the door 35B. The right wall portion 39 is an example of a peripheral wall portion among the peripheral wall portion of the outer body 31A, which is accessible by a person from the outside and excludes the front wall portion 36 and the rear wall portion 37. In the modified example of FIG. 6, the work table 2 is not used.

In such a configuration, an opening 39a opened or closed by the door 35B is formed on the right wall portion 39. The second hinge 38B rotatably supporting the door 35B is provided, for example, at an edge of the opening 39a. The rotation shaft of the second hinge 38B supporting the door 35B is, for example, parallel to an up-and-down direction.

In the modified example of FIG. 6, the clerk stands on the right side of the right wall portion 39. In the modified example of FIG. 6, the second display unit 73 is provided facing the right side of the clerk.

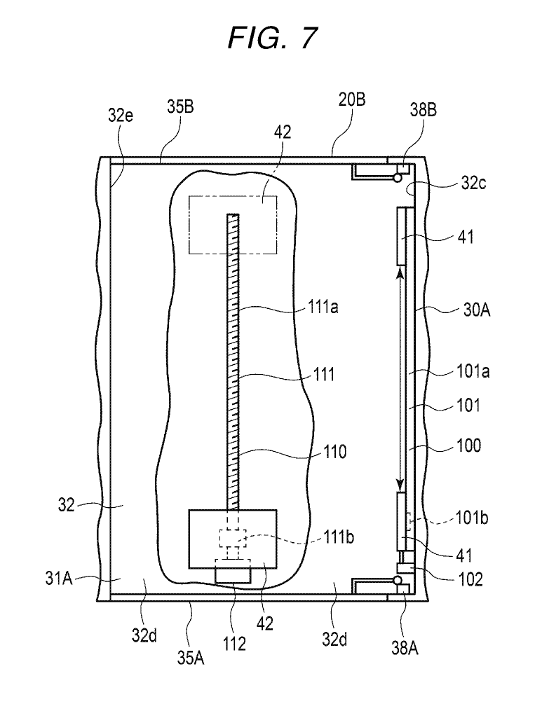

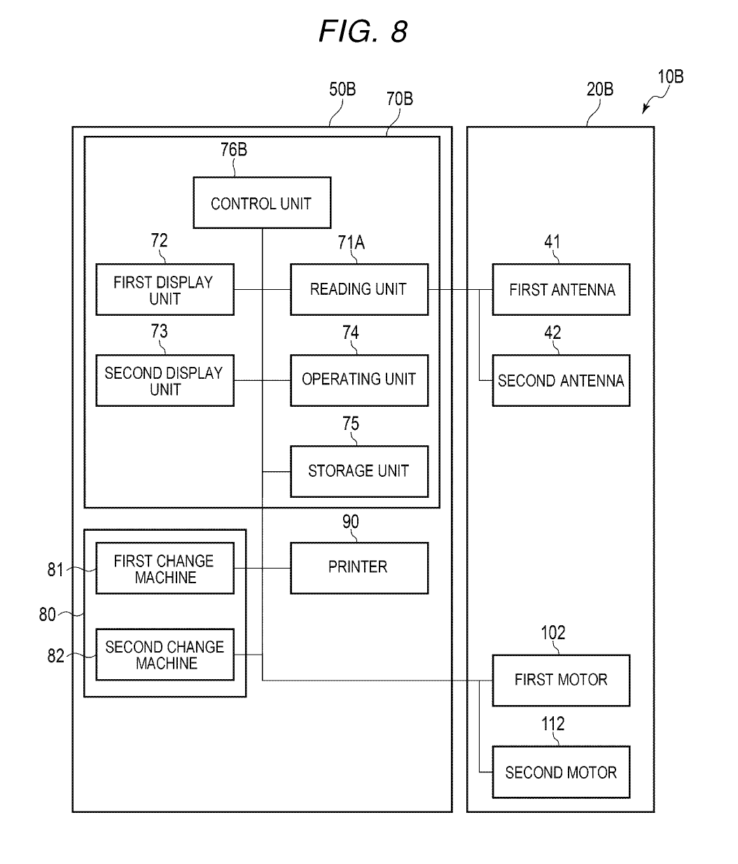

Next, a product sales processing apparatus 10B according to a third embodiment will be described with reference to FIGS. 7 and 8. Here, components having the same functions as the second embodiment are denoted with the same reference numerals as the second embodiment, and descriptions thereof are omitted.

FIG. 7 is a schematic diagram showing a configuration of a reading apparatus 20B used in the product sales processing apparatus 10B. In FIG. 7, the inside of the accommodating chamber 32 is viewed from the above. FIG. 8 is a block diagram showing a configuration of the product sales processing apparatus 10B.

The appearance of the product sales processing apparatus 10B is, for example, the same as that of the product sales processing apparatus 10A. The product sales processing apparatus 10B is different from the product sales processing apparatus 10A in that the first antenna 41 and the second antenna 42 are configured to be movable.

As shown in FIG. 8, the product sales processing apparatus 10B includes the reading apparatus 20B and a processing apparatus 50B.

As shown in FIG. 7, the reading apparatus 20B includes the reading apparatus main body 30A, the first antenna 41, the second antenna 42, a first driving unit 100, and a second driving unit 110.

The reading apparatus main body 30A includes the outer body 31A and the accommodating chamber 32.

The first antenna 41 is supported at the right surface 32c by the first driving unit 100. The second antenna 42 is supported below the bottom surface 32d by the second driving unit 110. For example, the second antenna 42 is supported by the second driving unit 110 at a rear surface (opposite to the bottom surface 32d) of a wall portion having the bottom surface 32d or another support portion provided below the wall portion having the bottom surface 32d.

The first driving unit 100 is configured to move the first antenna 41 back and forth. The first driving unit 100 includes, for example, a ball screw, and moves the first antenna 41 in the front-and-back direction by the ball screw. The first driving unit 100 includes, for example, a first ball screw 101 and a first motor 102.

The first ball screw 101 includes a first screw 101a and a first nut 101b. The first screw 101a is rotatably supported at the right surface 32c. The first screw 101a extends in parallel to the front-and-back direction.

The first nut 101b is fixed to the first antenna 41. Also, the first nut 101b is threadedly engaged with the first screw 101a. When the first screw 101a rotates, the first nut 101b moves along the first screw 101a. When the first nut 101b moves, the first antenna 41 is moved in the front-and-back direction.

The first motor 102 rotates the first screw 101a in both directions. When the first screw 101a rotates in one direction, the first antenna 41 is moved forward. When the first screw 101a rotates in the other direction, the first antenna 41 is moved backward. The first motor 102 is controlled by a control unit 76B described later.

The first driving portion 100 configured as such is arranged in a space secured for installation of the first and second hinges 38A and 38B.

The second driving unit 110 is configured to move the second antenna 42 back and forth. The second driving unit 110 includes, for example, a ball screw, and the second antenna 42 is moved in the front-and-back direction by the ball screw. For example, the second driving unit 110 includes a second ball screw 111 and a second motor 112. Also, in FIG. 7, a part of a bottom plate constituting the bottom surface 32d is shown to be partially cut. The second driving unit 110 and the second antenna 42 are shown through such a cut.

The second ball screw 111 includes a second screw 111a and a second nut 111b. The second screw 111a is, for example, rotatably supported by a rear surface of a wall portion having the bottom surface 32d or another support portion below the wall portion. The second screw 111a is parallel in the front-and back direction.

The second nut 111b is fixed to the second antenna 42. Also, the second nut 111b is threadedly engaged with the second screw 111a. When the second screw 111a rotates, the second nut 111b moves along the second screw 111a. When the second nut 111b moves, the second antenna 42 is moved in the front-and-back direction.

The second motor 112 rotates the second screw 111a in both directions. When the second screw 111a rotates in one direction, the second antenna 42 is moved forward. When the second screw 111a rotates in the other direction, the second antenna 42 is moved backward. The second motor 112 is controlled by the control unit 76B described below.

The first driving unit 100 and the second driving unit 110 are also configured to receive a signal from the RFID tag 6 of the product 5 at any position in the accommodating chamber 32, by the first antenna 41 and the second antenna 42.

In detail, a moving range of the first antenna 41 in the front-and-back direction and a moving range of the second antenna 42 in the front-and-back direction are set so as to be capable of receiving a signal from the RFID tag 6 of the product 5 by the first antenna 41 or the second antenna 42, regardless of a position of the product 5 in the accommodating portion 32.

The moving range of the first antenna 41 in the front-and-back direction is defined by the length of the first screw 101a. The moving range of the second antenna 42 in the front-and-back direction is defined by the length of the second screw 111a. In the present embodiment, for example, the first and second screws 101a and 111a extend from the vicinity of the front surface 32a of the accommodating chamber 32 up to the vicinity of the rear surface 32b.

The configuration of the first driving unit 100 is not limited to moving the first antenna 41 by the first ball screw 101. The configuration of the second driving unit 110 is also not limited to moving the second antenna 42 by the second ball screw 111. As another example, a moving device other than a ball screw is used.

The processing apparatus 50B includes, for example, the housing 60, a terminal 70B, the change machine 80, and the printer 90.

The terminal 70B includes the reading unit 71A, the first display unit 72, the second display unit 73, the operating unit 74, the storage unit 75, and the control unit 76B.

The control unit 76B is, for example, a central processing unit (CPU), or the like. The control unit 76B is electrically connected to the reading unit 71A, the first display unit 72, the second display unit 73, the operating unit 74, the storage unit 75, the change machine 80, the printer 90, the first motor 102, and the second motor 112. The control unit 76B controls each of the electrically connected components by a program stored in the storage unit 75.

The control unit 76B controls the reading unit 71A to read the information of the RFID tag 6 through the first and second antennas 41 and 42. The control unit 76B controls the reading unit 71 to write information on the RFID tag 6 through the first and second antennas 41 and 42. The control unit 76B controls the reading unit 71A, the first and second display units 72 and 73, and the change machine 80 to perform the sales registration process and the payment process.

Also, the control unit 76B controls the first motor 102 and the second motor 112 to control movement of the first antenna 41 and movement of the second antenna 42.

As an example of controlling the movement of the first antenna 41 and the movement of the second antenna 42 by the control unit 76B through the first and second motors 102 and 112, the first antenna 41 and the second antenna 42 may be moved while relative positions of the first antenna 41 and the second antenna 42 are uniformly maintained. In this example, a distance from a front end to a rear end of the moving range of the first antenna 41 and a distance from a front end to a rear end of the moving range of the second antenna 42 are set to be the same, while the first antenna 41 and the second antenna 42 are moved in the same direction at the same speed.

Alternatively, the first antenna 41 and the second antenna 42 may be moved while changing the relative positions of the first antenna 41 and the second antenna 42. In this example, a moving speed of the first antenna 41 and a moving speed of the second antenna 42 are set to different speeds.

Further, the control unit 76B may move the first antenna 41 and the second antenna 42 back and forth. Such reciprocating motion may be one time or a plurality of times.

When the first antenna 41 and the second antenna 42 are moved back and forth only one time within the respective moving ranges, the first antenna 41 and the second antenna 42 may be moved back and forth at different times as an example of a moving manner, while changing the relative positions of the first antenna 41 and the second antenna 42. The distance from the front end to the rear end of the moving range of the first antenna 41 and the distance from the front end to the rear end of the moving range of the second antenna 42 may be different distances.

When moved back and forth a plurality of times, a phase difference may be set to a cycle of reciprocating motion of the first antenna and a cycle of reciprocating motion of the second antenna 42 as a manner of moving the first antenna 41 and the second antenna 42 while changing the relative positions of the first antenna 41 and the second antenna 42.

As an example of a method of generating the phase difference, a time according to one reciprocating motion of the first antenna 41 and a time according to one reciprocating motion of the second antenna 42 are set to different times. As an example, when the distance from the front end to the rear end of the moving range of the first antenna 41 and the distance from the front end to the rear end of the moving range of the second antenna 42 are the same, the moving speed of the first antenna 41 and the moving speed of the second antenna 42 are set to different speeds.

As another example of the method of generating the phase difference, the distance from the front end to the rear end of the moving range of the first antenna 41 and the distance from the front end to the rear end of the moving range of the second antenna 42 are set to different distances, while the moving speed of the first antenna 41 and the moving speed of the second antenna 42 are the same speed.

As another example of the method of generating the phase difference, the distance from the front end to the rear end of the moving range of the first antenna 41 and the distance from the front end to the rear end of the moving range of the second antenna 42, and the moving speed of the first antenna 41 and the moving speed of the second antenna 42 are set to be the same, while a movement start time of the first antenna 41 and a movement start time of the second antenna 42 may be different.

A method of delaying the cycles when the first antenna 41 and the second antenna 42 are moved back and forth a plurality of times is not limited to the above. A phase difference may be set to the cycle of the reciprocating motion of the first antenna 41 and the cycle of the reciprocating motion of the second antenna 42 by other method.

Next, an example of a reading operation of the product 5 by the product sales processing apparatus 10B will be described. For example, when the customer operates the operating unit 74 after putting the product 5 into the accommodating chamber 32, the control unit 76B controls the reading unit 71A to start reading the RFID tag 6 of the product 5 in the accommodating chamber 32 through the first antenna 41 and the second antenna 42.

Further, the control unit 76B drives the first motor 102 to move the first antenna 41 in the front-and-back direction. Also, the control unit 76B drives the second motor 112 to move the second antenna 42 in the front-and-back direction. At this time, the control unit 76B moves the first antenna 41 and the second antenna 42 while uniformly maintaining the relative positions of the first antenna 41 and the second antenna 42 as described above.

Alternatively, the control unit 76B moves the first antenna 41 and the second antenna 42 while changing the relative positions of the first antenna 41 and the second antenna 42 as described above.

Further, one of the movement, in which the relative positions of the first antenna 41 and the second antenna 42 are uniformly maintained, and the movement, in which the relative positions of the first antenna 41 and the second antenna 42 are changed, is set in advance. Also, as an example in the present embodiment, the first antenna 41 and the second antenna 42 are moved while changing the relative positions.

Radio waves emitted by the first antenna 41 are emitted in an elliptical shape elongated in the left-and-right direction in a plane view according to characteristics thereof. Radio waves emitted by the second antenna 42 are emitted in an elliptical shape elongated in the up-and-down direction in a plane view according to characteristics thereof.

When the first antenna 41 is moved in the front-and-back direction, null points of the radio waves emitted by the first antenna 41 and radio waves reflected on an inner surface of the accommodating chamber 32 are moved. Similarly, when the second antenna 42 is moved in the front-and-back direction, null points of the radio waves emitted by the second antenna 42 and radio waves reflected on the inner surface of the accommodating chamber 32 are moved.

When the moving speed of the first antenna 41 and the moving speed of the second antenna 42 are different, the null points of the radio waves emitted from the first antenna 41 and the radio waves emitted from the second antenna 42 are also moved.

By moving the null points as such, the RFID tag 6 of the product 5 is prevented from being always positioned at the null point.

The control unit 76B prepares a product list of the products 5 accommodated in the accommodating chamber 32 according to read information. When the preparation of the product list is completed, the control unit 76B displays the product list on the first display unit 72 and the second display unit 73. When the product 5 displayed on the first display unit 72 and the product 5 accommodated in the accommodating chamber 32 match each other, the customer performs works for proceeding to the payment process, such as operating the operating unit 74, and the like. When the works for proceeding to the payment process are performed, the control unit 76B stops driving the reading unit 71 and the first and second motors 102 and 112, and proceeds to the payment process. The works of the customer and the works of the clerk in the present embodiment are the same as those in the second embodiment.

The product sales processing apparatus 10B configured as such may have the same effects as the second embodiment.

Further, since the first antenna 41 is moved in the front-and-back direction, the accuracy of reading the RFID tag 6 of the product 5 in the accommodating chamber 32 by the first antenna 41 is improved. In other words, the radio waves emitted from the first antenna 41 are emitted from the first antenna 41 in the elliptical shape elongated in the left-and-right direction according to characteristics thereof. Thus, it is difficult for the radio waves emitted from the first antenna 41 of which position is fixed to reach all ranges within the accommodating chamber 32. Here, the radio waves emitted from the first antenna 41 do not include the radio waves reflected on the inner surface of the accommodating chamber 32.

However, in the present embodiment, the first antenna 41 is moved in the front-and back direction of the accommodating chamber 32, and thus the radio waves emitted from the first antenna 41 reaches a wide range within the accommodating chamber 32. The moving range of the first antenna 41 may be a range in which the radio waves emitted from the first antenna 41 reach the entire area in the accommodating chamber 32.

As such, when the first antenna 41 is moved in the front-and-back direction, the accuracy of reading the product 5 in the accommodating chamber 32 by the first antenna 41 is improved.

Furthermore, since the second antenna 42 is moved in the front-and-back direction, the accuracy of reading in the accommodating chamber 32 by the second antenna 42 is improved like the first antenna 41. The moving range of the second antenna 42 may also be set to a moving range in which the radio waves emitted from the second antenna 42 reach the entire area in the accommodating chamber 32.

Since the first antenna 41 is moved, the null points of the radio waves emitted from the first antenna 41 and the radio waves reflected on the inner surface of the accommodating chamber 32 are moved. Accordingly, the RFID tag 6 of the product 5 is prevented from being always positioned at the null point. Thus, the accuracy of reading the RFID tag 6 of the product 5 in the accommodating chamber 32 by the first antenna 41 is improved.

Since the second antenna 42 is moved, the null points of the radio waves emitted from the second antenna 42 and the radio waves reflected on the inner surface of the accommodating chamber 32 are moved. Accordingly, the RFID tag 6 of the product 5 is prevented from being always positioned at the null point. Thus, the accuracy of reading the RFID tag 6 of the product 5 in the accommodating chamber 32 by the second antenna 42 is improved.

Further, the first antenna 41 and the second antenna 42 are moved while changing the relative positions. As an example, a phase difference is set to correspond to a cycle of reciprocating motion when the first antenna 41 and the second antenna 42 are moved back and forth a plurality of times. Accordingly, the null points of the radio waves emitted from the first antenna 41 and the radio waves emitted from the second antenna 42 are moved. Thus, the accuracy of reading of the RFID tag 6 in the accommodating chamber 32 is improved.

In the present embodiment, the first antenna 41 and the second antenna 42 are configured to be movable. However, it is not limited that both the first antenna 41 and the second antenna 42 are configured to be movable. In another example, only one of the first antenna 41 and the second antenna 42 is configured to be movable. In other words, the product sales processing apparatus 10B may include only one of the first driving unit 100 and the second driving unit 110.

In the present embodiment, the movable first antenna 41 and the movable second antenna 42 are provided at the reading apparatus 20B including the accommodating chamber 32 into which or out of which the product 5 is put through the two doors 35A and 35B. However, the movable first antenna 41 and the movable second antenna 42 are not limited to being provided at a reading apparatus including the accommodating chamber 32 into which or out of which the product 5 is put through two doors.

At least one of the movable first antenna 41 and the movable second antenna 42 may be provided at a reading apparatus including the accommodating chamber 32 into which or out of which the product 5 is input through one door 35, as in the reading apparatus 20 described in the first embodiment.

According to the embodiments and the modified example described above, a time required for completion of a bagging work of a product may be reduced.

The configurations of the processing apparatuses 50, 50A, and 50B are not limited to those described in the first, second, and third embodiments. For example, the processing apparatus 50, 50A, or 50B may further include a card reader and a communication unit. The card reader reads information of a card used by the customer for payment. The communication unit is a communication interface configured to communicate with an external device. The communication unit transmits product information obtained by the reading unit 71 or 71A to the outside.

The reading apparatuses 20, 20A, and 20B according to the first, second, and third embodiments may each further include a moving mechanism capable of moving the bottom surface 32d of the accommodating chamber 32 in a horizontal direction. When the product 5 is read, the control unit 76, 76A, or 76B drives the moving mechanism to move the product 5 in the accommodating chamber 32 in the horizontal direction, for example, in the front-and-back direction and the left-and-right direction. When the product 5 is moved, the accuracy of reading of the product 5 is improved.

The product sales processing apparatuses 10, 10A, and 10B according to the first, second, and third embodiments are semi-self-service-type product sales processing apparatuses. However, the product sales processing apparatuses 10, 10A, and 10B may be used as self-service-type product sales processing apparatuses, with which customers are expected to complete all processing.

The reading apparatus 20A and 20B described in the second and third embodiments may further include a door opening and closing mechanism. The door opening and closing mechanism is operated by the customer and opens the closed door 35A. The door opening and closing mechanism includes, for example, an operating unit stepped on by the customer with a foot. The door opening and closing mechanism opens the door 35A when the operating unit is stepped on. The door 35A is closed when the foot is taken off the operating unit. A similar door opening and closing mechanism may also be provided to open or close the door 35B. This door opening and closing mechanism is operated by the clerk.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A reading apparatus comprising:
a body having therein a chamber configured to accommodate a container to carry one or more products, the body having an opening facing upward and through which the container is placeable into the chamber;
an opening cover movably attached to the body between an open position that enables the container to pass through the opening and a closed position that closes the opening; and
a radio frequency identification (RFID) antenna positioned to read data in an RFID tag on at least part of the one or more products in the chamber.

2. The reading apparatus according to claim 1, wherein the RFID antenna is positioned at a bottom wall of the chamber.

3. The reading apparatus according to claim 2, further comprising an antenna driving unit configured to move the RFID antenna along the bottom wall.

4. The reading apparatus according to claim 1, wherein the RFID antenna is positioned at a side wall of the chamber.

5. The reading apparatus according to claim 4, further comprising an antenna driving unit configured to move the RFID antenna along the side wall.

6. The reading apparatus according to claim 1, further comprising a second RFID antenna positioned to read data in an RFID tag on at least part of the one or more products in the chamber, wherein the RFID antenna is positioned at a bottom wall of the chamber and the second RFID antenna is positioned at a side wall of the chamber.

7. The reading apparatus according to claim 6, further comprising:
a first antenna driving unit configured to move the RFID antenna along the bottom wall; and
a second antenna driving unit configure to move the second RFID antenna along the side wall.

8. The reading apparatus according to claim 6, further comprising:
a controller configured to control the first antenna driving unit and the second antenna driving unit, such that a relative position of the RFID antenna and the second RFID antenna changes.

9. The reading apparatus according to claim 1, wherein the opening cover is slidable between the open position and the closed position.

10. The reading apparatus according to claim 1, further comprising:
a controller configured to perform sales registration processing based on the data read from the RFID tag on the at least part of the one or more products in the chamber.

11. A reading apparatus comprising:
a body having therein a chamber configured to accommodate a container to carry one or more products, the body having a first opening on a first side of the chamber and a second opening on a second side of the chamber opposite to the first side;
a first opening cover movably attached to the body between a first open position that enables the container to pass through the opening and a first closed position that closes the opening;
a second opening cover movably attached to the body between a second open position that enables the container to pass through the opening and a second closed position that closes the opening; and
a radio frequency identification (RFID) antenna positioned to read data in an RFID tag on at least part of the one or more products in the chamber.

12. The reading apparatus according to claim 11, wherein the RFID antenna is positioned at a bottom wall of the chamber.

13. The reading apparatus according to claim 12, further comprising an antenna driving unit configured to move the RFID antenna along the bottom wall.

14. The reading apparatus according to claim 11, wherein the RFID antenna is positioned at a side wall of the chamber.

15. The reading apparatus according to claim 14, further comprising an antenna driving unit configured to move the RFID antenna along the side wall.

16. The reading apparatus according to claim 11, further comprising a second RFID antenna positioned to read data in an RFID tag on at least part of the one or more products in the chamber, wherein the RFID antenna is positioned at a bottom wall of the chamber and the second RFID antenna is positioned at a side wall of the chamber.

17. The reading apparatus according to claim 16, further comprising:
a first antenna driving unit configured to move the RFID antenna along the bottom wall; and
a second antenna driving unit configure to move the second RFID antenna along the side wall.

18. The reading apparatus according to claim 16, further comprising:
a controller configured to control the first antenna driving unit and the second antenna driving unit, such that a relative position of the RFID antenna and the second RFID antenna changes.

19. The reading apparatus according to claim 11, wherein the first opening cover is rotatable about a first rotational axis on an edge of the first opening, and the second opening cover is rotatable about a second rotational axis on an edge of the second opening.

20. The reading apparatus according to claim 11, further comprising:
a controller configured to perform sales registration processing based on the data read from the RFID tag on the at least part of the one or more products in the chamber.
